(19) United States
(12) Patent Application Publication
(10) Pub. No.: US 2016/0283945 A1
(43) Pub. Date: Sep. 29, 2016

(54) USER PROFILE PARAMETERS FOR FINANCIAL ACCOUNTS

(71) Applicant: Emmanuel GONZALEZ, Makari City (PH)

(72) Inventor: Emmanuel GONZALEZ, Makati City (PH)

(21) Appl. No.: 15/038,706

(22) PCT Filed: Feb. 4, 2015
(86) PCT No.: PCT/IB2015/000604

§ 371 Date: May 23, 2016

Related U.S. Application Data
(60) Provisional application No. 62/004,041, filed on May 28, 2014.

(51) Int. Cl. G06Q 20/40; G06Q 20/34; G06Q 20/10; H04L 29/08

(52) U.S. Cl. CPC G06Q 20/40145; H04L 67/306; G06Q 20/348; G06Q 20/105

(57) ABSTRACT

The disclosure allows each account holder to provide to the account issuer information about his or her account usage habits and intended future uses. The information provided may be stored by the account issuer on, for example, a central database which could be referenced each time the account is used or each time it is used for an amount exceeding a pre-set amount. If the proposed attempted use falls into the categories of restricted usages stored on the central database, then the transaction may be denied, or flagged and other types of confirmation required from the person attempting the transaction.

### CROSS REFERENCE TO RELATED APPLICATIONS

This application claims the benefit of U.S. Provisional Application Ser. No. 62/004,041, filed May 28, 2014, entitled “User Profile Parameters For Financial Accounts”.

### TECHNICAL FIELD

The embodiments disclosed herein relate generally to the field of financial transactions, and more specifically, to methods and systems for using a user profile parameter to prevent fraud in credit card and other types of electronic financial transactions.

### BACKGROUND

A growing concern of credit card and other financial companies is the theft of cards, account numbers, and account information which may then be used to facilitate fraudulent transactions. The global amount of losses due to fraud of such types has been estimated on the low end at $11 billion annually. Issuers of credit cards have tried numerous mechanisms to protect against fraud, for example, 3-digit security codes imprinted on the back of the card, embedded microchips in the card itself, additional “security codes” for online use, and passwords and personal-identification-numbers (PINs) of various kinds. Nonetheless, the incidence of fraud continues to grow. Further, each layer of “protection” tends to complicate the use of the card for the card holder. This may be especially true for large transactions. This additional complexity means that issuing institutions lose money not just from fraud but also from lost legitimate transactions. For example, U.S. Pat. No. 8,145,562 is directed to a method for assessing the riskiness of a given proposed transaction. However, the '562 patent does not use actual stated intentions or instructions from a cardholder. Similarly, U.S. Pat. No. 8,588,748 discloses another probability-based method of detecting potentially fraudulent transactions, however, it does not rely on clearly-expressed input from the cardholder.

U.S. Pat. No. 8,078,515 discloses traditional methods of validating an identity. Although it does elicit the cooperation of the account holder, the account holder's input is limited to selecting ways in which his identity may be verified. US Application 20100274691 discloses an algorithm that evaluates actual past usage to determine whether a proposed transaction is consistent with past behavior. This approach also relies on how well a programmer can guess future behavior from the past, so can still allow fraudulent transactions to go through.

Therefore, there is a need in the art for improved methods for detecting fraud using input from the account holder to insure greater accuracy and convenience.

Another drawback to conventional fraud protection systems is that it is very costly to manage and provide systems that address “false positives.” These false positives may lead to suspended accounts and interrupted transactions, further inconveniencing the legitimate card holder and potentially causing lost revenue for the issuer. In addition to credit cards, there are also debit cards, online bank accounts, conventional bank accounts, online currency, and other types of financial settlement accounts and systems that face similar issues.

### BRIEF DESCRIPTION OF DRAWINGS

FIG. 1 is a diagram illustrating an example questionnaire to create a user profile according to an embodiment;

FIG. 2 is a diagram illustrating an example questionnaire to create a user profile according to an embodiment; and

FIG. 3 is a diagram illustrating an example questionnaire for a vendor to provide identification information for the type of goods subject to a particular purchase.

FIG. 4 is a diagram illustrating a system for securely processing a financial transaction according to an embodiment of the disclosure.

### SUMMARY OF THE DISCLOSURE

What is needed is a system which eliminates the need for a financial-account issuing institution to guess or infer (by use of algorithms, predictive statistics, and similar data) whether a proposed transaction is legitimate. The need for guesswork is eliminated, or at any rate greatly reduced, by providing each account holder the means to specify in advance how the account may be used, or is likely to be used, by converting these specifications of a multitude of account-holders into a database, and providing means for financial-account issuing institutions to access the database. The implementation of such a system would allow the identification, with a high degree of certainty, of attempted fraudulent transactions, thus greatly reducing the losses suffered by financial institutions such as credit-card issuers and others. In one embodiment, a computer system for processing financial transactions is provided. The computer system includes a transaction-processing computer having a data base that stores a user profile for an account holder, the user profile including one or more user profile parameters that restrict permitted uses of a financial account associated with the account holder, a configuration computer that is accessible by the account holder that allows the account holder to create or modify the user profile corresponding to the financial account, and a vendor communication computer that receives transaction information from a vendor related to purchases made using the financial account. The transaction-processing computer disallows an attempted purchase if the purchase does not meet the user profile parameters. A disallowed transaction may be later allowed if a user can provide suitable identifying or other information demonstrating that the transaction is allowed by the account holder.

The user profile parameters may comprise at least one of a maximum amount of transaction, a specified currency of transaction, a geographic location of a vendor or merchant, a geographic location or specific addresses to which goods or purchases may be sent, a type of good or service, a maximum value of total transactions per a specified time-period, or a name of recipient of transfers from the account.

The user profile parameters may include a specified time-delay which must elapse before any change or exception to the user profile parameters is allowed. In still further embodiments, the data base is connected to and accessed through the Internet, and in which the account holder is provided on-line entry fields for specifying his user profile and transaction preferences or instructions and the data base may be access-protected, for example, by use of a password, biometric data, code-generating device or code-book, or code-sheet.

In other embodiments, the account owner may modify any one, any combination, or all, of his user profile parameters permanently and the account owner may modify his user profile parameters temporarily or for a one-time transaction, at a time in advance of a specific intended use, or category of uses. The user profile parameters may include a minimum time delay prior to accepting a temporary or one-time-only transaction authorization. Also, the transaction information may include identifying data reflecting the types of goods or services that is the subject of the attempted purchase. The vendor may be required to input this information at the time of the transaction.

Embodiments may include different account types, including accounts associated with a credit card or a bank deposit account associated with a debit card, or the financial account may be a credit account, an online currency, an undertaking to provide payment or settlement, or a promise to redeem in currency or in any medium of exchange. In still further embodiments, the user profile parameter data base may be modified by a cell phone application or “app,” or the data base may be electronically linked to one or more separate financial account issuing institutions.

In still another embodiment, a method for processing financial transactions is provided. The method includes storing a user profile for an account holder on a data base accessible by a transaction processing computer, the user profile including one or more user profile parameters that restrict permitted uses of a financial account associated with the account holder, providing access by a configuration computer that allows the account holder to create or modify the user profile corresponding to the financial account, and receiving transaction information from a vendor communication computer related to purchases made using the financial account wherein the transaction processing computer disallows an attempted purchase if the purchase does not meet the user profile parameters.

### DETAILED DESCRIPTION OF DISCLOSED EMBODIMENTS

Embodiments of the disclosure may be described with respect to credit cards, however, it is to be understood that other embodiments may be readily implemented by persons skilled in the art for debit cards, prepaid cards, and online bank accounts and financial transactions, such as PayPal, which are vulnerable to similar types of fraud. In one embodiment, the disclosure provides a method for using a user profile in connection with a financial account that provides unique criteria to confirm that the person attempting to make the transaction is the legitimate account holder. In particular, credit card issuers have only generalized criteria for identifying what factors constitute a “suspicious transaction.” These criteria do not distinguish between the preferences of individual card holders, but, in effect, assume that all account-holders are alike.

One implementation of the disclosure allows each account holder to provide to the account issuer information about his or her account usage habits and intended future uses. This information may also be provided if the credit card holder is a commercial entity that wishes to provide company-issued cards to its employees which are limited to certain types of transactions and purchases. The information provided may be stored by the account issuer on, for example, a central database which could be referenced each time the account is used or each time it is used for an amount exceeding a pre-set amount. If the proposed attempted use falls into any of the categories of restricted usages stored on the central database, then the transaction may be denied, or at least flagged and other types of confirmation demanded from the person attempting the transaction.

In one implementation of the disclosure, the account holder may provide restrictions on the types of goods and services the card or account may be used to purchase. For example, many stolen-credit-card frauds involve the purchase of jewelry, watches or guns. However, many credit card holders do not intend to buy jewelry, watches, or guns on a particular credit card or account. If an attempt is made to purchase jewelry, watches or guns on this particular card or account, then it may be detected by comparing the attempt with the user profile containing the restriction information stored on the central database. The transaction could then be denied or delayed until additional confirmation could be provided demonstrating that the attempt was a legitimate purchase by the account holder.

In another implementation, the account holder may provide restrictions on the geographical locations where the card may be used, or where purchases or other transactions may be made. For example, the account holder may specify whether he or she would like the card to be limited to use in particular countries, or, if within the United States, whether the card or account should be limited to a certain State or States.

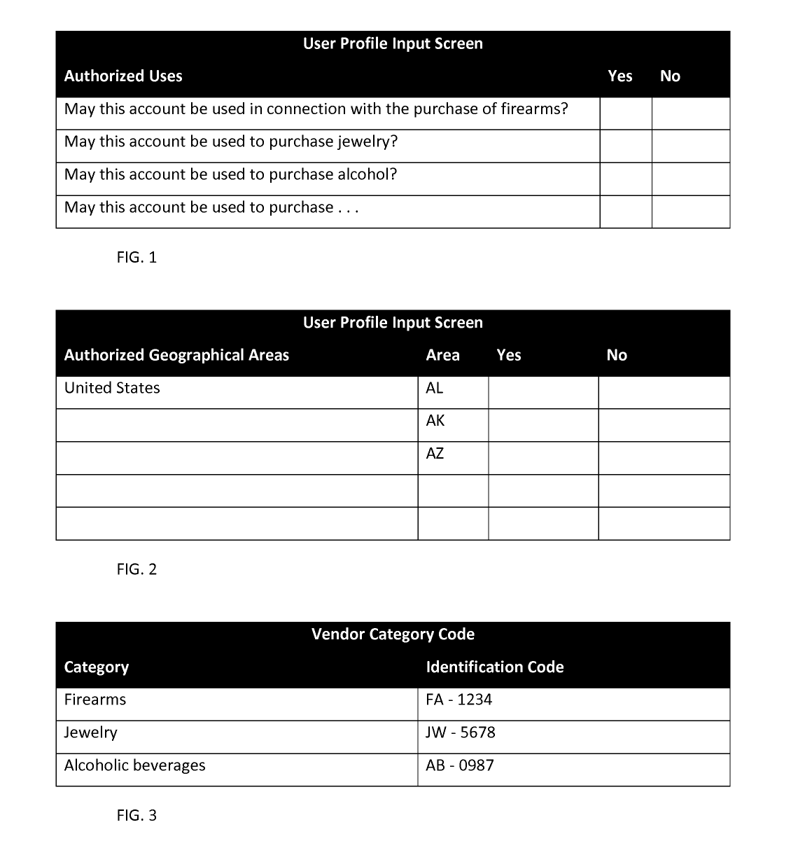

An account holder may provide the restriction information to the card or account issuing institution by accessing an online registry. In this implementation, an account holder may access his account through a computer network, such as the Internet. To gain access, he may be asked to provide his identifying information and any passwords or PINS. At this point, the user may be asked for any restrictions he or she wishes to place on the account associated with his profile. For example, with respect to FIG. 1, the user may be provided an online questionnaire to stipulate details on how to limit the use of the card, or to provide advance guidance on his spending or financial-transaction habits. An example may be “May this account be used in connection with the purchase of firearms? Yes or No.” Similar questions may be posed for jewelry, clothing, or any other category of goods and services, particularly those of a type most commonly purchased in fraudulent transactions.

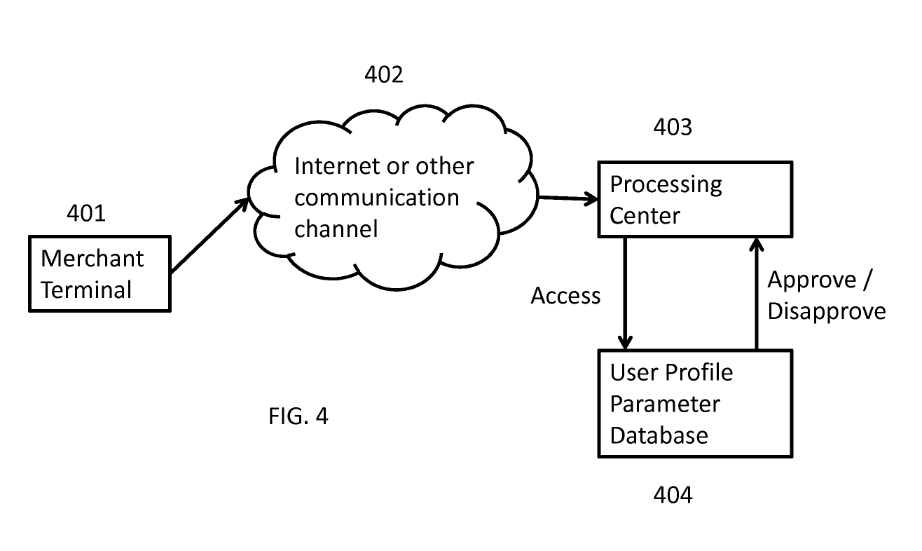

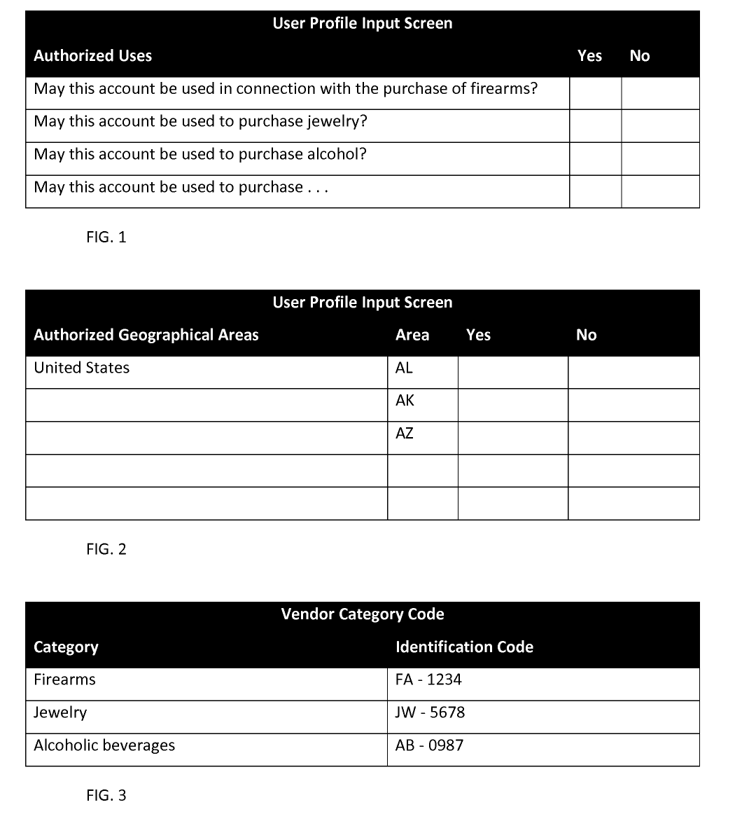

In another embodiment, the online questionnaire may pose questions about restrictions on geographical use. For example, referring to FIG. 2, the questionnaire may ask “Do you wish your card to be limited geographically to use in a particular State or States? Please mark all applicable.” A list of states may follow. Similar questions may be posed for other countries or territories. FIG. 3 shows a potential questionnaire by a lender for providing information related to the type of good or service that is being purchased in a transaction. The codes may be developed by the vendors themselves, or provided in guidelines of the account-issuing institution to vendors wishing to make charges against the account. At the time of the purchase, the vendor may associate the transaction code with the type of product and send this information to the issuing institution. This allows the issuing institution to compare the type of good or service being purchased the information provided by the account holder concerning what type of goods and services may be purchased on the account. If a transaction is being attempted that involves the purchase of a good or service that is not permitted, according to the user profile, set up by the accountholder, then this transaction may be flagged at the transaction computer of the account-issuing financial institution. The transaction may be disallowed or a communication may be sent to the account holder requesting additional information or confirmation that the transaction is legitimate. Thus, each account holder may, in advance, identify the kinds of transactions to allow. Thus, in embodiments of the invention, there is no need to assess the “riskiness,” of the transaction but rather the proposed transaction is compared with the restrictions placed on the account by the account holder himself. For example, the owner of a credit card may declare that his card will only be used for online purchases, and only for delivery to specified addresses, but never, for example, ATM withdrawals or face-to-face transactions. Thus, if the card were ever to be used at a gas station, the transaction would be identified with certainty as fraudulent. Of course, temporary modifications may also be allowed by the user, as described in detail below. This also allows fraud prevention to begin at the very outset of opening an account, rather than waiting until an actual transaction is attempted. It also allows for fraud prevention using the user's actual self-disclosed intentions, rather than an algorithm designed to predict levels of risk.

Other embodiments may allow account holders to specify specific merchants or recipients, for example, “Expedia” or “Four Seasons Hotels.” These restrictions may be positive or negative, that is, purchases from, or payments to, these merchants may be either barred by the restrictions, or certain merchants or venders may be designated as the exclusive providers for certain services or goods when purchases are made using the account.

Moreover, primary card holders could thereby limit the ways in which sub-holders, or officers under a corporate account, could spend.

An account holder may have occasions in which it is desirable or useful to remove or alter the restrictions on the card or account after they have been established. Such amendments may be either permanent or for a limited time, such as a vacation or other trip outside of the geographical area, for the isolated purchase of a unique item, or for a change in the way the card or account will be used in the future. For example, through the Internet, an account holder may access his profile and, with a preset number of days advance notice, alter his profile, either permanently, or only for a specific transaction, or only for a limited duration. Thus, with an appropriate time-delay, exceptions could be authorized by the account holder. For example, an account holder who typically does not buy jewelry could access the system to inform the card issuer that he intends to buy a watch from a specific store, and be allowed to do so after a 2-day delay, or similar predetermined time period. This simple time-delay mechanism, after an input by the account-holder himself, would frustrate a large number of fraudulent transactions.

In another embodiment, there may be a limit on the number of outstanding such exception orders. This delay and the limit would give an additional level of protection, during which time the account holder might realize that his log-in data had been compromised, or may help limit the loss to one single transaction. Similarly, account holders who are about to travel could specify the countries in which transactions would be authorized and for what time periods.

According to embodiments of the disclosure, when a transaction is attempted on an account registered in the system, the issuing institution may access the database, which compares the use being requested with the profile created by the account holder. The system may then either approve or disapprove the transaction based on the comparison of the attempted transaction with the restrictions on transactions stored by the database. A profile that, for example, limited the card to use in the United States may detect any use which involved an establishment or shipping address in another country and would immediately flag the proposed transaction as fraudulent, allowing the issuing institution to take appropriate measures.

In still further embodiments, a system according to this disclosure would be a means of pre-authorizing use, emanating from the account holder himself. It may also be used as a “blacklist”, whereby an account holder could prohibit certain uses, perhaps out of concern he may himself lack self-control while, for example, on a trip to Las Vegas or to a country auction; or that one of his sub-account holders would otherwise spend irresponsibly.

The account-issuing institutions would benefit from lower losses due to fraud, as well as lower cost of maintaining systems to deal with suspicious or fraudulent activity. Some of these savings could be passed back to the account holders, who would also enjoy smoother use and less incidences of temporary account suspensions. Account holders would enjoy more precise control over how their accounts are used to settle transactions, both by themselves and by their sub-account holders.

In one or more embodiments, the disclosure provides a computer system, or systems, configured to accept guidance or instructions from financial account holders/owners about which kinds of usage or activity are expected, or that they wish to permit, on a specified account, based on any one, any combination, or all, of certain specified User Profile Parameters. The user profile parameters may include the maximum amount of the transaction, the currency of transaction, the geographic location of a vendor merchant, the geographic location or specific addresses to which goods or purchases may be sent, type of good or service that may be bought with the account, the maximum value of total transactions per specified time-period, the name of the recipient of transfers from the account, and the time-delay which must elapse before any change or exception to the User Profile Parameters is allowed.

The system according to the disclosure may be connected to and accessed through the Internet, and the account holder may be provided a questionnaire, form, date entry screen or other means for specifying his user profile and transaction preferences or instructions.

The system may be access-protected by password, biometric data, code-generating device or code-book, code-sheet, or any means by which the identity of the true owner of the account may be verified whether online or in person at a physical location such as but not limited to the point of sale.

The system may also allow the account owner to modify any one, any combination, or all, of his User Profile Parameters permanently. In other implementations, the system may allow the account owner to modify his User Profile Parameters temporarily or for a one-time-only transaction, or for a limited duration in time. This allows alerting the issuing institution to the specific intended use, or category of uses, such as for a specific vendor and/or a specific or approximate amount, a geographic area for which use should be permitted up to a certain date, or to the type of merchandise or service which should be permitted on a one-time basis, or with any other such limitation. The system may also allow either the account owner or the issuing institution to determine the minimum time delay prior to accepting a temporary or one-time-only transaction authorization.

The system may also require vendors or potential recipients of payments or remittances to identify the types of goods or services that they habitually sell or offer, and, at the time of a specific proposed transaction, the specific good or service that is being sought to be acquired through use of the financial account of a particular account holder.

In one or more embodiments, the system may include a financial account such as associated with a credit card account or any similar mechanism, with or without a physical card. In other embodiments, it may include a financial account such as a bank deposit operated by a debit card or any similar mechanism, with or without a physical card. In still further embodiments, the system may include a financial account such as a credit account, an online currency, an undertaking to provide payment or settlement, a promise to redeem in currency or in any medium of exchange, or any similar mechanism.

In other embodiments of the disclosure, the account holder may be given means to provide his Pre-Set Financial Transaction Profile in person, by mail, by the use of an “app” with or without the Internet, or by the transmission or submission of any data storage device or medium whether electronic, paper, or other.

In still further embodiments, the information or instructions provided by the holder of a financial account may be linked to a system or systems of one or more financial-account issuing institutions in which the function of such system(s) is to authorize, allow, disallow, flag as suspicious, execute, or suspend execution of a requested transaction.

In still further embodiments, a system is provided where in the account owner may modify his user profile parameters temporarily or for a one-time-only transaction, or for a limited duration in time, for the purpose of pre-alerting the issuer institution of the account for a specific intended use, or category of uses, such as for a specific vendor and a specific or approximate amount, a geographic area for which use should be permitted up to a certain date, a type of merchandise or service which should be permitted on a one-time basis, or with any other such limitation.

The account owner or the issuing institution may determine the minimum time delay prior to accepting a temporary or one-time-only transaction authorization.

Vendors or potential recipients of payments may, in some embodiments, be required to identify the types of goods or services that they habitually sell or offer, and, at the time of a specific proposed transaction, the specific good or service that is being sought to be acquired through use of the financial account of a particular account holder.

The financial account may be a credit card account or any similar mechanism, that may not include a physical card or the financial account is a bank deposit operated by a debit card or any similar mechanism, with or without a physical card. Any type of financial account may be used in embodiments of the invention, for example, the financial account may be a credit account, an online currency, an undertaking to provide payment or settlement, a promise to redeem in currency or in any medium of exchange, or any similar mechanism. The system may also allow the account holder to provide his pre-set financial transaction profile by mail, in person, by the use of an “app” without the Internet, or by the transmission or submission of any data storage device whether electronic, paper, or other. Of course, the database may not necessarily be limited to use by a single institution but may be shared among multiple institutions, for example, if the account holder has multiple credit cards. In this way, the system may be linked.

The information or instructions provided by the holder of a financial account may be linked to a system or systems of one or more financial-account issuing institutions, which then allows these systems to authorize, allow, disallow, flag as suspicious, execute, or suspend execution of a requested transaction.

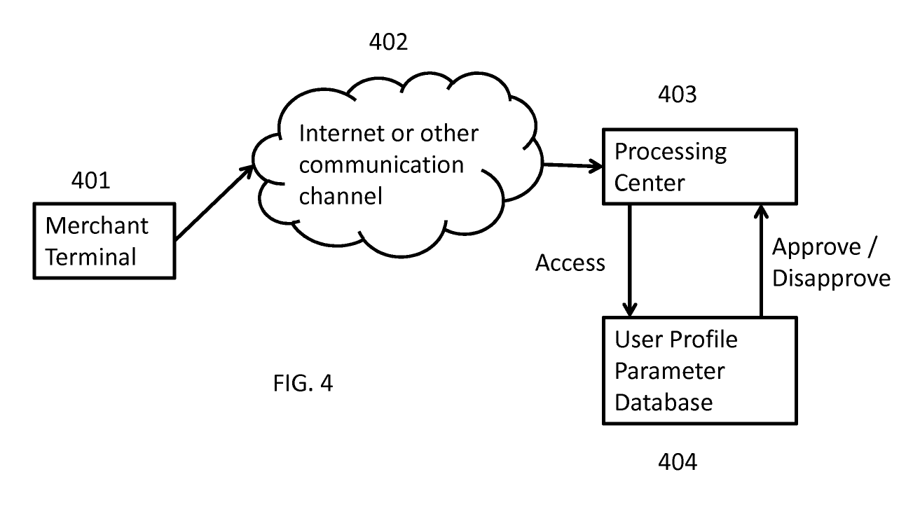

FIG. 4 is a diagram illustrating a system for performing a secure transaction according to one embodiment of the disclosure. The transaction is originally initiated at the Merchant Terminal 401. The Merchant Terminal 401 may be any conventional terminal for performing point-of-sale transactions, such as a credit/debit card reader. The Merchant Terminal 401 sends the amount, location, merchant ID, name of the credit/debit card holder, and number of account through an electronic connection, such as the Internet 402, to Processing Center 403.

Processing Center 403 then accesses the User Profile Parameter Database 404. The User Profile Parameter Database 404 stores the user profile information. The Processing Center 403 may be connected directly to the User profile Parameter Database 404, or it may access it remotely over an electronic connection such as the Internet. The User Profile Parameter Database 404 compares the attempted usage of the credit/debit card with the usages allowed by the card owner. Information indicating whether the transaction has been approved or disapproved is sent back to the Processing Center 403. Depending on the outcome of the comparison, the Processing Center may approve, disapprove, or even suspend an attempted transaction. In other embodiments, the Processing Center 403 may take other actions, such as providing notices of the transaction to the parties involved, or even to the authorities if it is determined that the card is being used for an unauthorized purpose.

Although the above embodiments have been described primarily with examples using credit cards, the disclosure may readily be extended to debit cards, prepaid credit cards, and all like systems whether involving an actual card or a financial account of whatever nature.

What is claimed is:

1. A computer system for processing financial transactions, the computer system comprising:
a. a transaction processing computer having a data base that stores a user profile for an account holder, the user profile including one or more user profile parameters that restrict permitted uses of a financial account associated with the account holder;
b. a configuration computer that is accessible by the account holder that allows the account holder to create or modify the user profile corresponding to the financial account;
c. a vendor communication computer that receives transaction information from a vendor related to transactions made using the financial account;
d. wherein the transaction processing computer disallows or flags an attempted transaction if the transaction does not meet the user profile parameters.

2. A computer system as in claim 1 wherein the user profile parameters comprise at least one of a maximum amount of transaction, a specified currency of transaction, a geographic location of a vendor or merchant, a geographic location or specific addresses to which goods or purchases may be sent, a type of good or service, a maximum value of total transactions per a specified time-period, or a name of recipient of transfers from the account.

3. A computer system as in claim 1, wherein the user profile parameters include a specified time-delay which must elapse before any change or exception to the user profile parameters is allowed or put into effect.

4. A computer system as in claim 1, wherein the data base is connected to and accessed through the Internet, and in which the account holder is provided on-line entry fields for specifying his user profile and transaction preferences or instructions.

5. A computer system as in claim 1 wherein the data base is access-protected.

6. A computer system as in claim 5, wherein the access protection comprises use of a password, biometric data, code-generating device or code-book, or code-sheet.

7. A computer system as in claim 1, wherein the account owner may modify any one, any combination, or all, of his user profile parameters permanently.

8. A computer system as in claim 1, wherein the account owner may modify his user profile parameters temporarily or for a one-time transaction, at a time in advance of a specific intended use, or category of uses.

9. A computer system as in claim 8, wherein the user profile parameters include a minimum time delay prior to accepting a temporary or one-time-only transaction authorization.

10. A computer system as in claim 1, wherein transaction information includes identifying data reflecting the types of goods or services that is the subject of the attempted purchase.

11. A computer system as in claim 1, wherein the financial account comprises activities associated with a credit card.

12. A computer system as in claim 1, wherein the financial account comprises a bank deposit account associated with a debit card.

13. A computer system as in claim 1, wherein the financial account comprises a credit account, an online currency, an undertaking to provide payment or settlement, or a promise to redeem in currency or in any medium of exchange.

14. A computer system as in claim 1, wherein the user profile parameter data base may be modified by a cell phone app, tablet app, or any similar mechanism.

15. A computer system as in claim 1, wherein the data base is electronically linked to and accessible by one or more separate financial account issuing institutions.

16. A method for processing financial transactions, the method comprising:
a. storing a user profile for an account holder on a data base accessible by a transaction processing computer, the user profile including one or more user profile parameters that restrict permitted uses of a financial account associated with the account holder;
b. providing access by a configuration computer that allows the account holder to create or modify the user profile corresponding to the financial account;
c. receiving transaction information from a vendor communication computer related to purchases made using the financial account;
d. wherein the transaction processing computer disallows an attempted purchase if the purchase does not meet the user profile parameters.

17. A method as in claim 16, wherein the user profile parameters comprise at least one of a maximum amount of transaction, a specified currency of transaction, a geographic location of a vendor or merchant, a geographic location or specific addresses to which goods or purchases may be sent, a type of good or service, a maximum value of total transactions per a specified time-period, or a name of recipient of transfers from the account.

18. A method as in claim 16, wherein the user profile parameters include a specified time-delay which must elapse before any change or exception to the user profile parameters is allowed.

19. A method as in claim 16, wherein the data base is connected to and accessed through the Internet, and in which the account holder is provided on-line entry fields for specifying his user profile and transaction preferences or instructions.

20. A method as in claim 16, wherein the data base is access-protected.
